(19) United States
(12) Patent Application Publication
(10) Pub. No.: US 2015/0182954 A1
(43) Pub. Date: Jul. 2, 2015

(54) Phase Stability of Lanthanum-Manganese Perovskite in the Mixture of Metal Oxides

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: Clean Diesel Technologies, Inc., Oxnard, CA (US)

(21) Appl. No.: 14/657,812

(22) Filed: Mar. 13, 2015

Related U.S. Application Data
(63) Continuation-in-part of application No. 13/911,986, filed on Jun. 6, 2013.

(51) Int. Cl. B01J 29/70; B01J 23/10; G01N 23/207; B01J 23/20; B01J 23/04; B01J 35/00; B01J 21/06; B01J 23/34

(52) U.S. Cl. CPC B01J 29/7049; B01J 21/066; B01J 23/10; B01J 23/34; B01J 23/20; B01J 23/04; B01J 35/0006; G01N 23/2076

(57) ABSTRACT

The present disclosure describes ZPGM material compositions including LaMnO₃ perovskite structure mixed with a plurality of support oxide powders to develop suitable ZPGM catalyst materials. Bulk powder ZPGM catalyst compositions are produced by physically mixing bulk powder LaMnO₃ perovskite with different support oxide powders calcined at about 1000° C. XRD analyses are performed for bulk powder ZPGM catalyst compositions to determine La—Mn perovskite phase formation and phase stability for a plurality of temperatures to about 1000° C. ZPGM catalyst material compositions including La—Mn perovskite structure mixed with doped zirconia, La₂O₃, cordierite, and ceria-zirconia support oxides present phase stability, which can be employed in ZPGM catalysts for a plurality of DOC applications, thereby leading to a more effective utilization of ZPGM catalyst materials with high thermal and chemical stability in DOC products.

### CROSS-REFERENCE TO RELATED APPLICATIONS

This application is a continuation-in-part of U.S. patent application Ser. No. 13/911,986, filed Jun. 6, 2013, which is hereby incorporated by reference.

### BACKGROUND

1. Field of the Disclosure

This disclosure relates generally to catalyst materials, and more particularly, to La—Mn perovskite phase stability within a plurality of support oxides.

2. Background Information

Diesel engines offer superior fuel efficiency and greenhouse gas reduction potential. However, one of the technical obstacles to their broad implementation is the requirement for a lean nitrogen oxide (NO_{X}) exhaust system. Conventional lean NO_{X} exhaust systems are expensive to manufacture and are a key contributor to the premium pricing associated with diesel engine equipped vehicles. Unlike a conventional gasoline engine exhaust in which equal amounts of oxidants (O₂ and NO_{X}) and reductants (CO, H₂, and hydrocarbons) are available, diesel engine exhaust contains excessive O₂ due to combustion occurring at much higher air-to-fuel ratios (>20). This oxygen-rich environment makes the removal of NO_{X} much more difficult.

Conventional diesel exhaust systems employ diesel oxidation catalyst (DOC) technology and are referred to as diesel oxidation catalyst (DOC) systems. Typically, DOC systems include a substrate structure upon which promoting oxides are deposited. Bimetallic catalysts, based on platinum group metals (PGM), are then deposited upon the promoting oxides.

Although PGM catalyst materials are effective for toxic emission control and have been commercialized by the emissions control industry, PGM materials are scarce and expensive. This high cost remains a critical factor for wide spread applications of these catalyst materials. Therefore, there is a need to provide a lower cost DOC system exhibiting catalytic properties substantially similar or to or better than the catalytic properties exhibited by DOC systems employing PGM catalyst materials.

### SUMMARY

The present disclosure describes Zero-Platinum Group Metals (ZPGM) material compositions including LaMnO₃ perovskite structure mixed with a plurality of support oxide powders to develop suitable ZPGM catalyst materials. Further, present disclosure describes a process for identifying suitable support oxides capable of providing high chemical reactivity and thermal and chemical stability when mixed with LaMnO₃ perovskite structure to form the aforementioned ZPGM catalyst materials.

According to some embodiments, ZPGM catalyst compositions are produced by physically mixing bulk powder LaMnO₃ perovskite with selected support oxide powders with a weight ratio of about 1:1. In these embodiments, La—Mn perovskite structure is produced as described in U.S. patent application Ser. No. 13/911,986. Further to these embodiments, support oxide powders selected are doped zirconia (ZrO₂—Pr₆O₁₁), Nb₂O₅, BaO, La₂O₃, ceria-zirconia (75% CeO₂-25% ZrO₂), cordierite, or mixtures thereof.

In some embodiments, bulk powder ZPGM catalyst compositions are produced to determine LaMnO₃ perovskite phase stability. LaMnO₃ perovskite phase formation and stability are analyzed/measured using X-ray diffraction (XRD) analyses. In these embodiments, XRD data is analyzed to determine if the structure of the LaMnO₃ perovskite remains stable. If the structure of the LaMnO₃ perovskite becomes unstable, new phases will form within the ZPGM catalyst materials. La—Mn perovskite phase stability that results from the use of selected support oxide powders indicate that ZPGM catalyst compositions including stable La—Mn perovskite structure mixed with selected support oxides can be employed for catalyst applications, and more particularly, for ZPGM catalysts. Disclosed ZPGM catalyst compositions can provide an essential advantage given the economic factors involved when completely or substantially PGM-free materials can be used to manufacture ZPGM catalysts for a plurality of DOC applications.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 is a graphical representation illustrating an X-ray diffraction (XRD) phase stability analysis of LaMnO₃ perovskite and calcined at about 800° C., according to an embodiment.

FIG. 2 is a graphical representation illustrating an XRD phase stability analysis of LaMnO₃ perovskite after mixing with Pr-doped zirconia support oxide and calcined at about 1000° C., according to an embodiment.

FIG. 3 is a graphical representation illustrating an XRD phase stability analysis of LaMnO₃ perovskite after mixing with niobium pentoxide support oxide and calcined at about 1000° C., according to an embodiment.

FIG. 4 is a graphical representation illustrating an XRD phase stability analysis of LaMnO₃ perovskite after mixing with barium oxide support oxide and calcined at about 1000° C., according to an embodiment.

FIG. 5 is a graphical representation illustrating an XRD phase stability analysis of LaMnO₃ perovskite after mixing with lanthanum oxide support oxide and calcined at about 1000° C., according to an embodiment.

FIG. 6 is a graphical representation illustrating an XRD phase stability analysis of LaMnO₃ perovskite after mixing with ceria-zirconia support oxide and calcined at about 1000° C., according to an embodiment.

FIG. 7 is a graphical representation illustrating an XRD phase stability analysis of LaMnO₃ perovskite after mixing with cordierite and calcined at about 1000° C., according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms have the following definitions:

“Platinum Group Metals (PGM)” refers to platinum, palladium, ruthenium, iridium, osmium, and rhodium.

“Zero-PGM (ZPGM) catalyst” refers to a catalyst completely or substantially free of PGM.

“Catalyst” refers to one or more materials that may be of use in the conversion of one or more other materials.

“Calcination” refers to a thermal treatment process applied to solid materials, in presence of air, to bring about a thermal decomposition, phase transition, or removal of a volatile fraction at temperatures below the melting point of the solid materials.

“Diesel oxidation catalyst (DOC)” refers to a device that utilizes a chemical process in order to break down pollutants within the exhaust stream of a diesel engine, turning them into less harmful components.

“Perovskite” refers to a catalyst having ABO₃ structure of material, which may be formed by partially substituting element “A” and “B” base metals with suitable non-platinum group metals.

“Treating, treated, or treatment” refers to drying, firing, heating, evaporating, calcining, or mixtures thereof.

“X-ray diffraction (XRD) analysis” refers to a rapid analytical technique that identifies crystalline material structures, including atomic arrangement, crystalline size, and imperfections in order to identify unknown crystalline materials (e.g., minerals, inorganic compounds).

### DESCRIPTION OF THE DRAWINGS

The present disclosure describes Zero-Platinum Group Metals (ZPGM) material compositions including LaMnO₃ perovskite structure mixed with a plurality of support oxide powders to develop suitable ZPGM catalyst materials. Further, present disclosure describes a process for identifying suitable support oxides capable of providing high chemical reactivity and thermal and chemical stability when mixed with LaMnO₃ perovskite structure to form the aforementioned ZPGM catalyst materials.

Perovskite-type oxides have turned out to be a group of promising catalysts for NO oxidation in automotive exhaust treatment, because of their low cost, good activity and thermal stability. Perovskite oxides and their promoted derivations can be dispersed as fine particles, optionally supported on a base metal oxide or some other suitable support material, to optimize the oxide accessible surface area and achieve the most effective oxidation of NO_{X}.

ZPGM Catalyst Material Composition and Preparation

The disclosed ZPGM material compositions in form of bulk powder are produced from perovskite of LaMnO₃. In some embodiments, bulk powder of LaMnO₃ perovskite is produced as described in U.S. patent application Ser. No. 13/911,986.

In some embodiments, bulk powder LaMnO₃ perovskite is physically mixed with selected support oxide powders with a weight ratio of about 1:1. Then, mixture of bulk powder LaMnO₃ perovskite and selected support oxide powders is calcined at a plurality of temperatures within a range from about 600° C. to about 1000° C. In these embodiments, calcination is preferably performed at about 1000° C. for about 5 hours. Further to these embodiments, support oxide powders selected to determine the La—Mn perovskite phase stability are doped zirconia (ZrO₂—Pr₆O₁₁), Nb₂O₅, BaO, La₂O₃, ceria-zirconia (75% CeO₂-25% ZrO₂), cordierite, or mixtures thereof.

X-Ray Diffraction Analysis for LaMnO₃ Perovskite Phase Stability

According to some embodiments, perovskite phase formation and stability are subsequently analyzed/measured using X-ray diffraction (XRD) analyses. In these embodiments, XRD data is then analyzed to determine if the structure of the LaMnO₃ perovskite remains stable. If the structure of the LaMnO₃ perovskite becomes unstable, new phases will form within the ZPGM catalyst material. Further to these embodiments, different calcination temperatures will result in different LaMnO₃ perovskite phases.

In some embodiments, XRD patterns are measured on a powder diffractometer using Cu Ka radiation in the 2-theta range of about 15°-100° with a step size of about 0.02° and a dwell time of about 1 second. In these embodiments, the tube voltage and current are set to about 40 kV and about 30 rnA, respectively. The resulting diffraction patterns are analyzed using the International Center for Diffraction Data (ICDD) database to identify phase formation. Examples of powder diffractometer include the MiniFlex™ powder diffractometer available from Rigaku® of The Woodlands, Tex.

In other embodiments, XRD analyses identify suitable chemical compositions of the La—Mn perovskite that when mixed with selected support oxide powders possess phase stability at a plurality of temperatures of operation in DOC applications.

Lanthanum-Manganese Perovskite Phase Stability

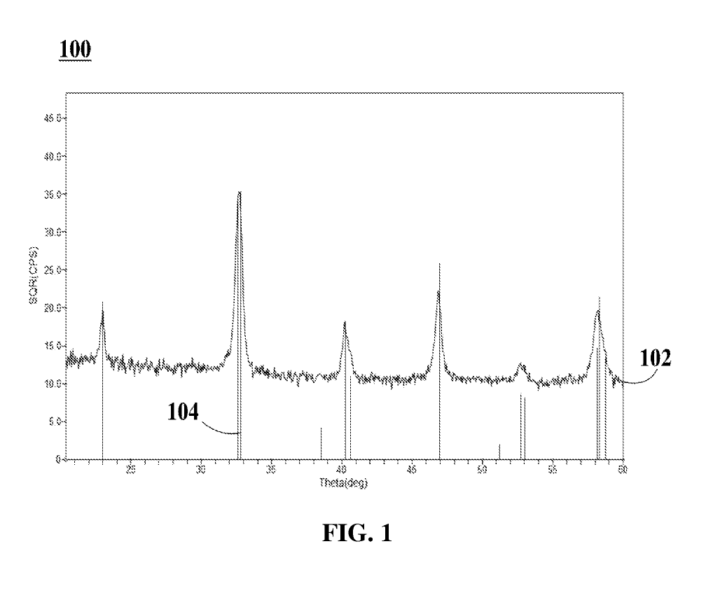

FIG. 1 is a graphical representation illustrating an X-ray diffraction (XRD) phase stability analysis of LaMnO₃ perovskite and calcined at about 800° C., according to an embodiment.

In FIG. 1, XRD analysis 100 includes XRD spectrum 102 and solid lines 104. XRD spectrum 102 illustrates bulk powder La—Mn perovskite calcined at a temperature of about 800° C. In some embodiments and after calcination, pure LaMnO₃ perovskite arranged in a rhombohedral structure is produced, as illustrated by solid lines 104, and the pure LaMnO₃ perovskite includes no contaminants and no separate oxide phases.

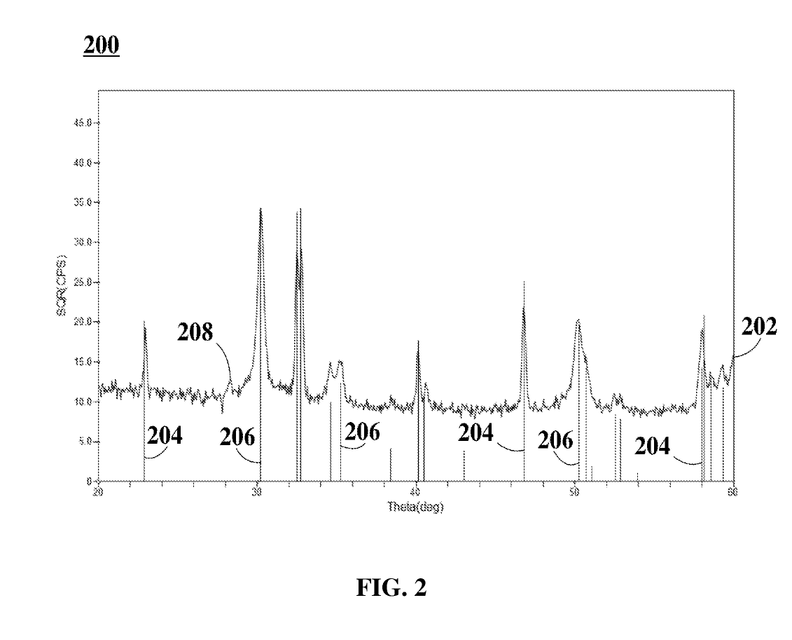

FIG. 2 is a graphical representation illustrating an XRD phase stability analysis of LaMnO₃ perovskite after mixing with Pr-doped zirconia support oxide and calcined at about 1000° C., according to an embodiment.

In FIG. 2, XRD analysis 200 includes XRD spectrum 202, solid lines 204, solid lines 206, and diffraction peak 208. XRD spectrum 202 illustrates bulk powder LaMnO₃ perovskite mixed with Pr-doped zirconia support oxide powder and calcined at a temperature of about 1000° C. In some embodiments and after calcination, LaMnO₃ perovskite arranged in a rhombohedral structure is produced, as illustrated by solid lines 204, thereby indicating that La—Mn perovskite decomposition does not occur and separate oxide phases are not formed. In FIG. 2, a tetragonal zirconia (ZrO₂) phase from the support oxide is detected, as illustrated by solid lines 206. In some embodiments, praseodymium oxide (Pr₆O₁₁) as a dopant of support oxide is also detected, as illustrated by diffraction peak 208. In these embodiments, the La—Mn perovskite and the zirconia show no chemical interaction, and therefore, La—Mn perovskite is stable on Pr-doped zirconia support oxide.

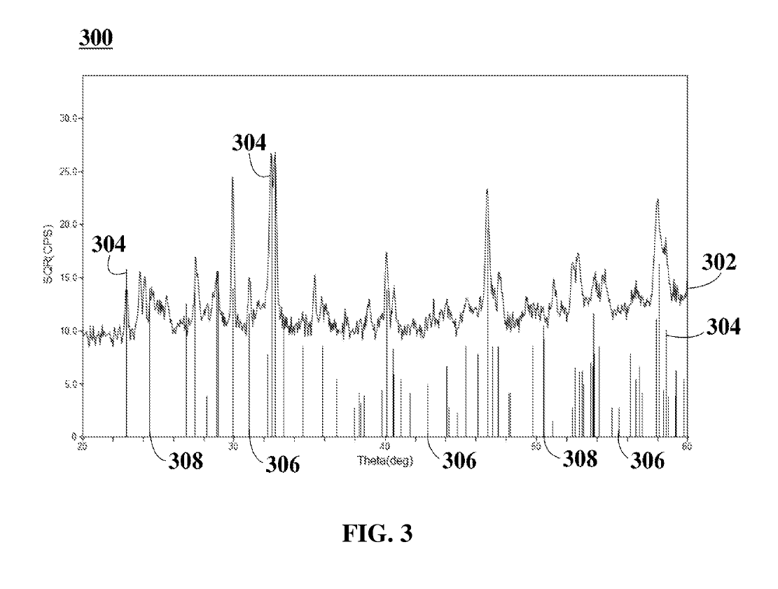

FIG. 3 is a graphical representation illustrating an XRD phase stability analysis for LaMnO₃ perovskite after mixing with Nb₂O₅ support oxide powder and calcined at about 1000° C., according to an embodiment.

In FIG. 3, XRD analysis 300 includes XRD spectrum 302, solid lines 304, solid lines 306, and solid lines 308. XRD spectrum 302 illustrates bulk powder La—Mn perovskite mixed with Nb₂O₅ support oxide powder and calcined at a temperature of about 1000° C. In some embodiments and after calcination, La—Mn perovskite arranged in a rhombohedral structure is produced, as illustrated by solid lines 304. In these embodiments, La—Mn perovskite is partially decomposed due to the presence of LaNbO₄ oxide, as illustrated by solid lines 306. Further to these embodiments, Nb₂O₅ support oxide is modified and arranged in a monoclinic structure, as illustrated by solid lines 308. The presence of LaMnO₃, Nb₂O₅ and LaNbO₄ phases indicate partial stability of La—Mn perovskite on the Nb₂O₅ support oxide. In some embodiments, the stability of La—Mn perovskite on the Nb₂O₅ support oxide may change when using different calcination temperatures.

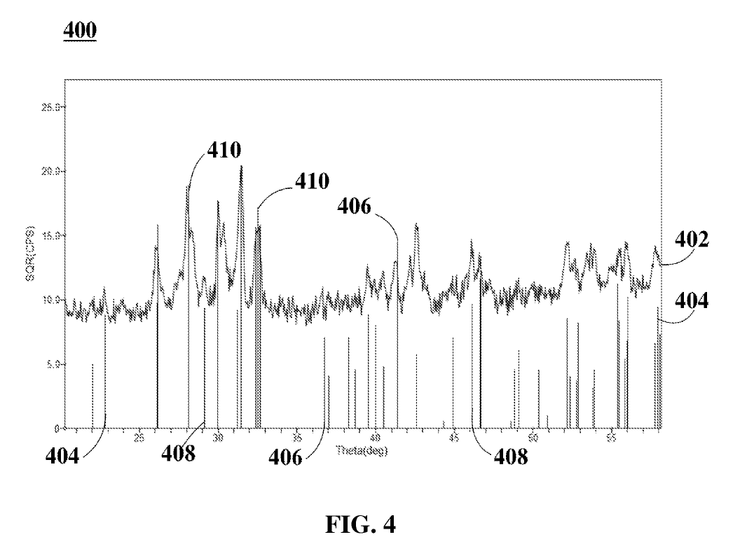

FIG. 4 is a graphical representation illustrating an XRD phase stability analysis for LaMnO₃ perovskite after mixing with BaO support oxide powder and calcined at about 1000° C., according to an embodiment.

In FIG. 4, XRD analysis 400 includes XRD spectrum 402, solid lines 404, solid lines 406, solid lines 408, and solid lines 410. XRD spectrum 402 illustrates bulk powder La—Mn perovskite mixed with BaO support oxide powder and calcined at a temperature of about 1000° C. In some embodiments and after calcination, a small intensity of La—Mn perovskite arranged in an orthorhombic structure is produced, as illustrated by solid lines 404, in addition to manganese oxide. In these embodiments, the presence of La₂O₃ arranged in a hexagonal structure indicates the decomposition of LaMnO₃ perovskite, as illustrated by solid lines 408. Further to these embodiments, La₂O₃ arranged in a hexagonal structure does not interact with the BaO support oxide.

In some embodiments, manganese oxide, the other perovskite decomposition product, interacts with the BaO support oxide and forms BaMnO_{3-X}, as illustrated by solid lines 406. The BaO support oxide arranged in a cubic structure exists as a separate phase, as illustrated by solid lines 410. In these embodiments, the La—Mn perovskite is not stable when mixed with the BaO support oxide and calcined as described above. The instability of the La—Mn perovskite is evidenced by the presence of a La₂O₃ phase and a BaMnO_{3-X} phase.

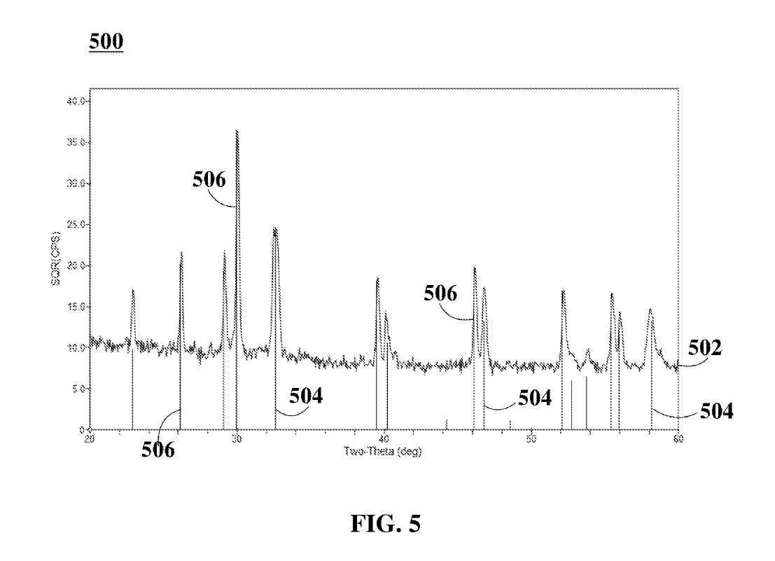

FIG. 5 is a graphical representation illustrating an XRD phase stability analysis for LaMnO₃ perovskite after mixing with La₂O₃ support oxide powder and calcined at about 1000° C., according to an embodiment.

In FIG. 5, XRD analysis 500 includes XRD spectrum 502, solid lines 504, and solid lines 506. XRD spectrum 502 illustrates bulk powder La—Mn perovskite mixed with La₂O₃ support oxide powder and calcined at a temperature of about 1000° C. In some embodiments and after calcination, LaMnO₃ perovskite arranged in a cubic structure is produced, as illustrated by solid lines 504. In these embodiments, La—Mn perovskite decomposition does not occur. Further to these embodiments, La₂O₃ is modified and arranged in a hexagonal structure, as illustrated by solid lines 506. In some embodiments, La—Mn perovskite and La₂O₃ exhibit no chemical interaction. Therefore, LaMnO₃ perovskite is stable when mixed with La₂O₃ support oxide.

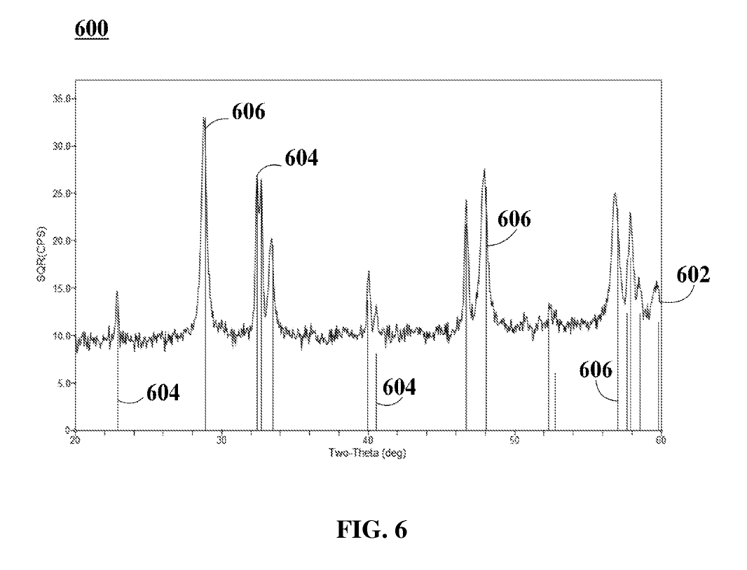

FIG. 6 is a graphical representation illustrating an XRD phase stability analysis for LaMnO₃ perovskite after mixing with ceria-zirconia support oxide powder and calcined at about 1000° C., according to an embodiment.

In FIG. 6, XRD analysis 600 includes XRD spectrum 602, solid lines 604, and solid lines 606. XRD spectrum 602 illustrates bulk powder La—Mn perovskite mixed with ceria-zirconia support oxide powder and calcined at a temperature of about 1000° C. In some embodiments and after calcination, LaMnO₃ perovskite arranged in a rhombohedral structure is produced, as illustrated by solid lines 604. In these embodiments, La—Mn perovskite decomposition does not occur when mixed with ceria-zirconia support oxide. Further to these embodiments, CeZrO₂ fluorite is produced from the support oxide and arranged in a cubic structure, as illustrated by solid lines 606. In some embodiments, LaMnO₃ perovskite and CeZrO₂ exhibit no chemical interaction. Therefore, LaMnO₃ perovskite is stable when mixed with ceria-zirconia support oxide.

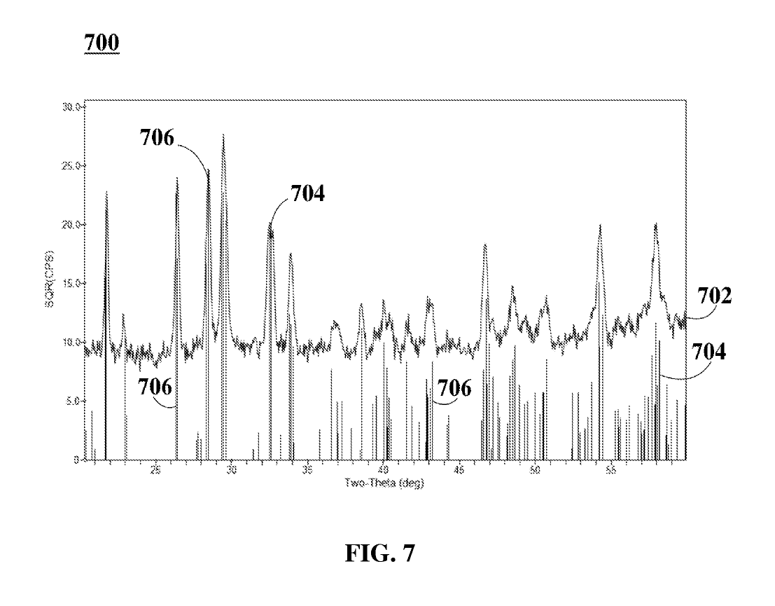

FIG. 7 is a graphical representation illustrating an XRD phase stability analysis for LaMnO₃ perovskite after mixing with cordierite and calcined at about 1000° C., according to an embodiment.

In FIG. 7, XRD analysis 700 includes XRD spectrum 702, solid lines 704, and solid lines 706. XRD spectrum 702 illustrates bulk powder La—Mn perovskite mixed with cordierite support oxide powder and calcined at a temperature of about 1000° C. In some embodiments and after calcination, LaMnO₃ perovskite arranged in a hexagonal structure is produced, as illustrated by solid lines 704. In these embodiments, La—Mn perovskite decomposition does not occur. Further to these embodiments, cordierite is modified and arranged in an orthorhombic structure, as illustrated by solid lines 706. In some embodiments, LaMnO₃ perovskite and cordierite exhibit no chemical interaction. Therefore, La—Mn perovskite is stable when mixed with cordierite support oxide.

According to the principles of this present disclosure, use of different support oxide powders brings different LaMnO₃ perovskite phase stabilities. The stabilities are determined from the XRD analysis results of the disclosed bulk powder catalyst compositions of perovskite and different support oxides. In the present disclosure, interaction of LaMnO₃ perovskite with Nb₂O₅ and BaO support oxides forms new phases, thereby indicating decomposition of La—Mn perovskite on Nb₂O₅ and BaO oxide powders, and instability of perovskite phase with these support oxides. Additionally, it is noted that doped zirconia, La₂O₃, cordierite and ceria-zirconia support oxides show no chemical interaction with La—Mn perovskite, thereby indicating that LaMnO₃ perovskite remains stable on doped zirconia, La₂O₃, cordierite and ceria-zirconia support oxides.

ZPGM catalyst material compositions including a La—Mn perovskite structure mixed with doped zirconia, La₂O₃, cordierite, or ceria-zirconia support oxides can be employed in ZPGM catalysts for a plurality of DOC applications. Using the aforementioned ZPGM catalyst material compositions results in a more effective utilization of ZPGM catalyst materials and exhibit high thermal and chemical stability in DOC products.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A composition comprising a catalyst comprising LaMnO₃ perovskite in weight ratio of about 1:1 to an oxide powder selected from the group consisting of ZrO₂—Pr₆O₁₁, Nb₂O₅, BaO, La₂O₃, CeO₂—ZrO₂, cordierite, or mixtures thereof.

2. The composition of claim 1, wherein the ceria-zirconia comprises 75% CeO₂.

3. The composition of clam 1, wherein the catalyst is calcined at about 1000° C.

4. A heat stable catalyst composition comprising LaMn perovskite on a support oxide of La₂O₃.

5. The composition of clam 4, wherein the catalyst is calcined at about 1000° C.

6. A catalyst comprising a mixture of LaMnO₃, Nb₃O₅, and LaNbO₄, wherein the mixture results from the calcination of LaMn perovskite on a support oxide of NbO₃.

7. The composition of clam 6, wherein the catalyst is calcined at about 1000° C.

8. A method for determining the phase stability of bulk La—Mn perovskite in selected support oxides, comprising:
providing a mixture comprising LaMnO₃ perovskite and a plurality of metals; and
analyzing the mixture using x-ray diffraction to produce a graph having at least one defined peak;
wherein at least one defined peak is representative of a stable LaMnO₃ perovskite and metal combination.

9. The method of claim 8, wherein at least one of the at least one defined peak represents a composition comprising LaMnO₃ perovskite in weight ratio of about 1:1 to an oxide powder selected from the group consisting of ZrO₂—Pr₆O₁₁, Nb₂O₅, BaO, La₂O₃, CeO₂—ZrO₂, and cordierite.

10. The method of claim 8, wherein at least one of the at least one defined peak represents a composition comprising a mixture of LaMnO₃, Nb₃O₅, and LaNbO₄, wherein the mixture results from the calcination of LaMn perovskite on a support oxide of NbO₃.

11. The method of claim 10, wherein the calcination is at about 1000° C.

12. The method of claim 8, wherein at least one of the at least one defined peak represents a composition comprising LaMn perovskite on a support oxide of La₂O₃.
